(19) United States
(12) Patent Application Publication
(10) Pub. No.: US 2023/0033792 A1
(43) Pub. Date: Feb. 2, 2023

(54) Optical Fiber Sensing System, Method and Apparatus for Simultaneously Measuring Temperature, Strain, and Pressure

(71) Applicants: Anhui University of Science & Technology, Huainan (CN); Geology Institute of China Chemical Geology and Mine Bureau, Beijing (CN)

(72) Inventors: Laigong Guo, Huainan (CN); Jingbin Zhu, Huainan (CN); Zhenhua Jiao, Huainan (CN); Jinpeng Wang, Huainan (CN); Wenjie Liu, Huainan (CN); Tao Jin, Huainan (CN); Mingsan Ouyang, Huainan (CN); Sen Jiao, Huainan (CN)

(21) Appl. No.: 17/588,877

(22) Filed: Jan. 31, 2022

(30) Foreign Application Priority Data
Jul. 27, 2021 (CN) 202110848451.0

(51) Int. Cl. G01D 21/02; G01B 11/16; G01L 11/02; G01K 11/32; G01L 19/04

(52) U.S. Cl. CPC G01D 21/02; G01B 11/165; G01L 11/025; G01K 11/32; G01L 19/04

(57) ABSTRACT

An optical fiber sensing system, method and apparatus for simultaneously measuring temperature, strain, and pressure are provided and belong to the field of optical fiber sensors. A distributed optical fiber temperature sensor is configured to monitor the temperature, and transmit the monitored temperature to a fiber grating strain and pressure sensor; the fiber grating strain and pressure sensor performs self temperature compensation based on received temperature; and the fiber grating strain and pressure sensor monitors the strain and the pressure. The distributed optical fiber temperature sensor is used to replace a temperature compensation function of the fiber grating strain sensor, and sense temperature distribution of each point along a route. Further, the fiber grating strain and pressure sensor is simplified inside, temperature demodulation is no longer required and speed of obtaining values of the strain and the pressure has been accelerated.

### CROSS REFERENCE TO RELATED APPLICATION

This patent application claims the benefit and priority of Chinese Patent Application No. 202110848451.0 filed on Jul. 27, 2021, the disclosure of which is incorporated by reference herein in its entirety as part of the present application.

### TECHNICAL FIELD

The disclosure belongs to the field of optical fiber sensors, and in particular relates to an optical fiber sensing system, method and apparatus for simultaneously measuring temperature, strain, and pressure.

### BACKGROUND ART

Since development of optical fiber sensing technology, it has been widely used in coal mines, oil fields, aviation, civil engineering and other scenarios, and can be used in situations in which a traditional sensor is difficult to be used, such as strong electromagnetic interference and strong corrosive environments.

Temperature is of great significance for many scenarios, and a wide range of measurements can be achieved by using a distributed optical fiber sensor. According to an actual situation, strain and pressure sensors are applied to a to-be-measured location point and are associated with temperature of the point to achieve temperature compensation, so that the strain and the pressure measured at this point are more accurate. This is especially important for an application scenario in which temperature, strain, and pressure need to be measured simultaneously, for example, coal mine geological exploration, where it need measure temperature, pressure, and strain in a drill to prevent water inrush and other problems, and avoid a geothermal abnormally high temperature area and strong groundwater flow area; and for another example, safety monitoring of a subway tunnel, and monitoring of different disasters of an operation tunnel such as deformation, temperature, and leakage.

### SUMMARY

In a first aspect, the disclosure aims to provide an optical fiber sensing system for simultaneously measuring temperature, strain, and pressure in view of shortcomings of the conventional art. According to the system, an internal structure of a grating strain and pressure sensor is simplified, and demodulation time of the grating strain and pressure sensor is shortened. Therefore, strain and pressure information to be measured can be obtained more quickly.

The effects of the disclosure can be achieved according to the following technical solutions.

The optical fiber sensing system for simultaneously measuring the temperature, the strain, and the pressure includes a distributed optical fiber temperature sensor and a fiber grating strain and pressure sensor.

The distributed optical fiber temperature sensor is configured to monitor the temperature, and transmit the monitored temperature to the fiber grating strain and pressure sensor.

The fiber grating strain and pressure sensor is configured to perform self temperature compensation based on received temperature.

The fiber grating strain and pressure sensor is further configured to monitor the strain and the pressure.

In some disclosures, an internal structure of the fiber grating strain and pressure sensor includes a circular metal diaphragm and two gratings, the two gratings are a pressure grating and a strain grating.

In a second aspect, the disclosure aims to provide a method for simultaneously measuring temperature, strain, and pressure in view of shortcomings of the conventional art. According to the method, an internal structure of a grating strain and pressure sensor is simplified, and demodulation time of the grating strain and pressure sensor is shortened. Therefore, strain and pressure information to be measured can be obtained more quickly.

The method for simultaneously measuring the temperature, the strain, and the pressure includes the following steps:

S1. monitoring the temperature by using a distributed optical fiber temperature sensor, and transmitting the monitored temperature to a fiber grating strain and pressure sensor;

S2. performing, by the fiber grating strain and pressure sensor, self temperature compensation based on received temperature; and

S3. monitoring the strain and the pressure by the fiber grating strain and pressure sensor.

In a third aspect, the disclosure aims to provide an apparatus for simultaneously measuring temperature, strain, and pressure in view of shortcomings of the conventional art. According to the apparatus, an internal structure of a grating strain and pressure sensor is simplified, and demodulation time of the grating strain and pressure sensor is shortened. Therefore, strain and pressure information to be measured can be obtained more quickly.

The apparatus for simultaneously measuring the temperature, the strain, and the pressure includes a distributed optical fiber temperature sensor and a fiber grating strain and pressure sensor.

The distributed optical fiber temperature sensor is configured to monitor the temperature, and transmit the monitored temperature to the fiber grating strain and pressure sensor.

The fiber grating strain and pressure sensor is configured to perform self temperature compensation based on received temperature.

The fiber grating strain and pressure sensor is further configured to monitor the strain and the pressure.

In some disclosures, an internal structure of the fiber grating strain and pressure sensor includes a circular metal diaphragm and two gratings, and the two gratings are a pressure grating and a strain grating.

The disclosure has the following beneficial effects:

The present disclosure uses the distributed optical fiber temperature sensor to replace a temperature compensation function of the fiber grating strain and pressure sensor, and sense temperature distribution of each point along a route. Further, the fiber grating strain and pressure sensor is simplified inside, temperature demodulation is no longer required, and speed of obtaining values of the strain and the pressure has been accelerated.

### BRIEF DESCRIPTION OF THE DRAWINGS

To describe the technical solutions in the embodiments of the disclosure or in the conventional art more clearly, the following briefly describes the accompanying drawings required for the description of the embodiments or the conventional art. Obviously, a person of ordinary skill in the art may still derive other accompanying drawings from these accompanying drawings without creative efforts.

FIG. 1 is a system flowchart of an embodiment of the disclosure;

FIG. 2 is a schematic diagram of an internal structure of an fiber grating strain and pressure sensor according to an embodiment of the disclosure; and

FIG. 3 is an overall schematic diagram of an embodiment of the disclosure.

### DETAILED DESCRIPTION OF THE EMBODIMENTS

The following clearly and completely describes the technical solutions in the embodiments of the disclosure with reference to accompanying drawings in the embodiments of the disclosure. Obviously, the described embodiments are merely a part rather than all of the embodiments of the disclosure. All other embodiments obtained by a person of ordinary skill in the art based on the embodiments of the disclosure without creative efforts shall fall within the scope of the present disclosure.

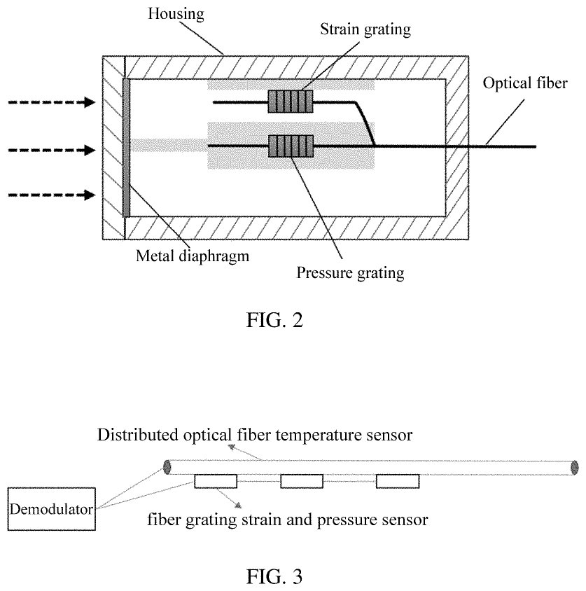

A fiber grating strain and pressure sensor is a cylindrical object as a whole, with a housing to wrap and protect the internal structure, a circular diaphragm at a bottom to increase sensitivity, and two gratings inside corresponding to pressure and strain. A tie rod structure is adopted for the pressure. A high-elastic metal diaphragm at the bottom is used for increasing sensitivity. Received pressure is applied to the metal diaphragm to cause a slight displacement, and then is transmitted to the tie rod structure, so as to change a reflection wavelength of the grating. The grating is fixed in the internal structure for the strain. Deformation caused by force is acted on the grating, so as to change a period and refractive index of the grating, as shown in FIG. 2.

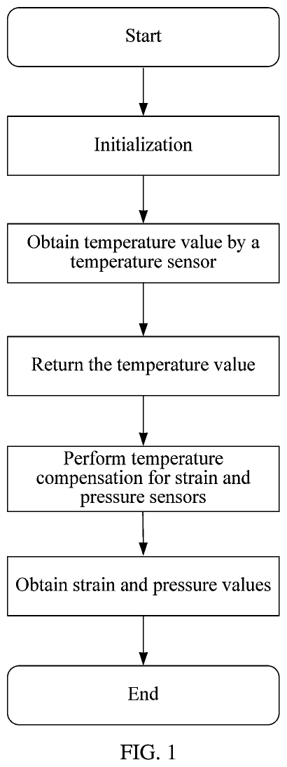

As shown in FIG. 1, according to the disclosure, the temperature is first measured by using a distributed optical fiber temperature sensor, then a temperature value is returned to the fiber grating strain and pressure sensor for temperature compensation, afterwards the strain and the pressure are measured, and finally the temperature, the strain, and the pressure are sensed. A temperature grating is required inside a previous fiber grating strain and pressure sensor to realize a function of the temperature compensation, so it is troublesome to measure the pressure and the strain simultaneously. The distributed optical fiber temperature sensor is used to replace the temperature grating to realize the function of the temperature compensation, and sense temperature distribution of each point along a route. Further, the fiber grating strain and pressure sensor is simplified inside, temperature demodulation is no longer required, and speed of obtaining values of the strain and the pressure has been accelerated.

Further, as shown in FIG. 3, the distributed optical fiber temperature sensor is a functional optical fiber sensor, that is, an entire optical fiber cable realizes two functions of transmission and sensing. A transmitted signal is finally demodulated into a temperature value by using a demodulator. A structure of a measuring part of the distributed optical fiber temperature sensor is an optical cable. The above-mentioned fiber grating strain and pressure sensor is of a single-point measurement type, and can only measure a parameter of a part at which the sensor is located. However, a plurality of fiber grating strain and pressure sensors can be connected in series by using a multiplexing technology, for example, three sensors below shown in FIG. 3. An overall structure is that the plurality of fiber grating strain and pressure sensors are connected, and then fixed on the temperature sensor to realize common measurement.

According to a principle of the distributed optical fiber temperature sensor, a Raman scattered light signal is more sensitive to the temperature, the temperature is sensed by collecting a Stokes Raman scattered light signal and an anti-Stokes Raman scattered light signal.

A defect in an optical fiber (caused in a manufacturing process, at an interconnection of different sections, or the like) may affect uniformity of a refractive index. When light passes through the optical fiber, photons collide inelastically with optical phonons of the optical fiber, that is, a Raman effect. In a scattered spectrum, a part with a wavelength smaller than that of an incident light is anti-Stokes light, and a part with a wavelength greater than that of the incident light is Stokes light. The Anti-Stokes signal is relatively sensitive to a change of the temperature, and therefore usually used as a signal channel, and the Stokes signal is used as a reference channel At any temperature T, a luminous flux ratio of the Anti-Stokes and the Stokes is:

$$\frac{{Φ}_{AS} ( T )}{{Φ}_{S} ( T )} = \frac{{K}_{AS}}{{K}_{S}} \cdot {( \frac{{v}_{AS}}{{v}_{S}} )}^{4} \cdot \frac{{R}_{AS} ( T )}{{R}_{S} ( T )} \cdot exp [ ( {α}_{S} - {α}_{AS} ) \cdot L ] \qquad ( 1 )$$

R_{AS} and R_{S} are temperature modulation functions of the Anti-Stokes and the Stokes, and a relationship is:

$${R}_{AS} ( T ) = {[ exp ( h Δ v / kT ) - 1 ]}^{- 1} \qquad ( 2 )$$

$${R}_{S} ( T ) = {[ 1 - exp ( - h Δ v / kT ) ]}^{- 1} \qquad ( 3 )$$

$$\frac{{Φ}_{AS} ( T )}{{Φ}_{S} ( T )} = \frac{{K}_{AS}}{{K}_{S}} \cdot {( \frac{{v}_{AS}}{{v}_{S}} )}^{4} \cdot exp [ - ( h Δ v / kT ) ] \cdot exp [ ( {α}_{S} - {α}_{AS} ) \cdot L ] \qquad ( 4 )$$

Assuming that a reference temperature is T₀, the ratio of the luminous fluxes of the Anti-Stokes and the Stokes at T₀ is:

$$\frac{{Φ}_{AS} ( {T}_{0} )}{{Φ}_{S} ( {T}_{0} )} = \frac{{K}_{AS}}{{K}_{S}} \cdot {( \frac{{v}_{AS}}{{v}_{S}} )}^{4} \cdot exp [ - ( h Δ v / {kT}_{0} ) ] \cdot exp [ ( {α}_{S} - {α}_{AS} ) \cdot L ] \qquad ( 5 )$$

$$\frac{{Φ}_{AS} ( T ) / {Φ}_{S} ( T )}{{Φ}_{AS} ( {T}_{0} ) / {Φ}_{S} ( {T}_{0} )} = exp [ \frac{h Δ v}{k} ( \frac{1}{{T}_{0}} - \frac{1}{T} ) ] \qquad ( 6 )$$

Final temperature value is:

$$T = \frac{h Δ {vT}_{0}}{h Δ v - {kT}_{0} ln \frac{{Φ}_{AS} ( T ) / {Φ}_{S} ( T )}{{Φ}_{AS} ( {T}_{0} ) / {Φ}_{S} ( {T}_{0} )}} \qquad ( 7 )$$

Where, Φ_{AS} and Φ_{S} are the luminous fluxes of the Anti-Stokes and the Stokes at temperature T; K_{AS} and K_{S} are section coefficients of the Anti-Stokes and the Stokes; v_{AS} and v_{S} are frequencies of photons of the Anti-Stokes and the Stokes photons; α_{AS} and α_{S} are losses of Anti-Stokes light and Stokes light transmitted through the optical fiber; L is a position of scattered light in the optical fiber; h is a Planck constant, and a value thereof is 6.626×10⁻³⁴ J·s; Δv is an optical phonon frequency of the optical fiber, and a value thereof is 1.32×10¹³ Hz; and k is a Boltzmann constant , and a value thereof is 1.38×10⁻²³ J·K.

For measurements of the strain and the pressure in the fiber grating strain and pressure sensor, a wavelength shift is affected by the period and the refractive index:

Δλ_{B}=2Λ·Δnₑ+2nₑ·ΔΛ (8)

Under an action of axial strain ε_{z}, the following can be obtained:

$$Δ ( \frac{1}{{n}_{e}^{2}} ) = ( {p}_{11} + {p}_{12} ) {ε}_{x} + {p}_{12} {ε}_{𝓏} \qquad ( 9 )$$

Transverse strain εₓ can be expressed as: εₓ=−με_{z}.

A relationship between a change of a grating period and the axial strain in an elastic range is:

$$\frac{ΔΛ}{Λ} = {ε}_{𝓏}$$

An effective elastic-optical coefficient is set as pₑ, and expressed as

$${p}_{e} = \frac{{n}_{e}^{2}}{2} [ {p}_{12} - μ ( {p}_{11} + {p}_{12} ) ]$$

Therefore, a wavelength shift caused by the strain is:

$$\frac{{Δλ}_{B}}{{λ}_{B}} = ( 1 - {p}_{e} ) {ε}_{𝓏} \qquad ( 10 )$$

Through the metal diaphragm, the strain can be related to the pressure. When the pressure is set as P, the axial strain under the pressure is expressed as:

ε_{z}=−P·(1−2μ)|E (11)

A relationship between the grating period and the pressure is: ΔΛ=Λ·ε_{z=-Λ·P·(}1−2μ)|E.

According to an elastic-optical effect of a material, the following can be obtained:

$$Δ {n}_{e} = \frac{1}{2} \cdot {n}_{e}^{3} \cdot [ {p}_{12} - v \cdot ( {p}_{11} + {p}_{12} ) ] \cdot ( 1 - 2 μ ) \cdot ( P / E ) \qquad ( 12 )$$

After the effective elastic-optical coefficient is substituted into the formula, the wavelength shift caused by the pressure is:

$$\frac{{Δλ}_{B}}{{λ}_{B}} = \frac{( 1 - 2 μ ) \cdot ( {p}_{e} - 1 )}{E} \cdot P \qquad ( 13 )$$

A wavelength shift caused by the temperature is:

$$\frac{{Δλ}_{B}}{{λ}_{B}} = ( α + ξ ) \cdot T \qquad ( 14 )$$

When three parameters act simultaneously, influence of the temperature needs to be considered, that is:

$$\frac{{Δλ}_{B}}{{λ}_{B}} = ( α + ξ ) \cdot T + \frac{( 1 - 2 μ ) \cdot ( {p}_{e} - 1 )}{E} \cdot P + ( 1 - {p}_{e} ) \cdot {ε}_{𝓏} \qquad ( 15 )$$

Where, the strain grating and the pressure grating are separated, so individual grating is only affected by the temperature and a corresponding parameter. If K_{T}=(α+ξ) λ_{B} expresses a temperature coefficient, Kₚ=(1−2v)(pₑ−1)λB/E expresses a pressure coefficient, and K_{ε}=(α+ξ)λ_{B} expresses a strain coefficient, and when the temperature T is known, the following can be obtained:

Δλ_{B1}=K_{T1}·T+K_{ε}·ε_{z} (16)

Δλ_{B2}=K_{T2}·T+Kₚ·P (17)

The strain and the pressure obtained after the temperature compensation can be expressed as:

$${ε}_{𝓏} = \frac{{Δλ}_{B 1} - {K}_{T 1} \cdot T}{{K}_{ε}} \qquad ( 18 )$$

$$P = \frac{{Δλ}_{B 2} - {K}_{T 2} \cdot T}{{K}_{p}} \qquad ( 19 )$$

Where, nₑ is an effective refractive index of the optical fiber, Λ is the period of the grating, α is a thermal expansion coefficient of an optical fiber material, ξ is a thermo-optical coefficient of the optical fiber material, μ is a Poisson's ratio of the optical fiber material, E is a Young's modulus of the optical fiber material, and p₁₁ and p₁₂ are elastic-optical coefficients and values thereof depend on a material used.

In the description of this specification, the description of the terms “one embodiment”, “example”, “specific example” or the like means that specific features, structures, materials or characteristics described with reference to the embodiment(s) or example(s) are included in at least one embodiment or example of the disclosure. In the specification, the schematic description of the above terms is unnecessarily against the same embodiment or example. Moreover, the particular features, structures, materials or characteristics described may be combined in any suitable manner in any one or more embodiments or examples.

The basic principles, main features, and advantages of the disclosure are shown and described above. It should be understood by those skilled in the art that, the disclosure is not limited by the aforementioned embodiments. The aforementioned embodiments and the description only illustrate the principle of the disclosure. Various changes and modifications may be made to the disclosure without departing from the spirit and scope of the disclosure. Such changes and modifications all fall within the claimed scope of the disclosure.

What is claimed is:

1. An optical fiber sensing system for simultaneously measuring temperature, strain, and pressure, comprising a distributed optical fiber temperature sensor and a fiber grating strain and pressure sensor; wherein
the distributed optical fiber temperature sensor is configured to monitor the temperature, and transmit the monitored temperature to the fiber grating strain and pressure sensor;
the fiber grating strain and pressure sensor is configured to perform self temperature compensation based on received temperature; and
the fiber grating strain and pressure sensor is further configured to monitor the strain and the pressure.

2. The optical fiber sensing system for simultaneously measuring the temperature, the strain, and the pressure according to claim 1, wherein an internal structure of the fiber grating strain and pressure sensor comprises a circular metal diaphragm and two gratings, the two gratings are a pressure grating and a strain grating.

3. A method for simultaneously measuring temperature, strain, and pressure, comprising:
S1. monitoring the temperature by using a distributed optical fiber temperature sensor, and transmitting the monitored temperature to a fiber grating strain and pressure sensor;
S2. performing, by the fiber grating strain and pressure sensor, self temperature compensation based on received temperature; and
S3. monitoring the strain and the pressure by the fiber grating strain and pressure sensor.

4. An apparatus for simultaneously measuring temperature, strain, and pressure, comprising a distributed optical fiber temperature sensor and a fiber grating strain and pressure sensor; wherein
the distributed optical fiber temperature sensor is configured to monitor the temperature, and transmit the monitored temperature to the fiber grating strain and pressure sensor;
the fiber grating strain and pressure sensor is configured to perform self temperature compensation based on received temperature; and
the fiber grating strain and pressure sensor is further configured to monitor the strain and the pressure.

5. The apparatus for simultaneously measuring the temperature, the strain, and the pressure according to claim 4, wherein an internal structure of the fiber grating strain and pressure sensor comprises a circular metal diaphragm and two gratings, the two gratings are a pressure grating and a strain grating.
